(19) United States
(12) Patent Application Publication
(10) Pub. No.: US 2026/0043455 A1
(43) Pub. Date: Feb. 12, 2026

(54) DRIVE BELT WTH CONDUCTING ELEMENTS

(71) Applicant: ContiTech Deutschland GmbH, Hannover (DE)

(72) Inventors: Martin Franke, Garbsen (DE); Nico Birkner, Hannover (DE); Joanna Kubiak, Hannover (DE); Tim Fiss, Hannover (DE); Susann Borchers, Nienburg (DE)

(73) Assignee: ContiTech Deutschland GmbH, Hannover (DE)

(21) Appl. No.: 19/102,175

(22) PCT Filed: Jul. 10, 2023
(86) PCT No.: PCT/DE2023/200139

§ 371 Date: Feb. 7, 2025

(30) Foreign Application Priority Data
Aug. 8, 2022 (DE) 10 2022 208 243.5

(51) Int. Cl. F16G 5/10; F16G 5/08; F16G 5/20

(52) U.S. Cl. CPC F16G 5/10; F16G 5/08; F16G 5/20

(57) ABSTRACT

The invention relates to a drive belt having a first conducting element, which is embedded in a polymer material for transmitting electrical energy, wherein the first conducting element is formed by at least one tensile member that extends in the longitudinal direction of the drive belt preferably a multiplicity of tensile members that extend in the longitudinal direction of the drive belt and are arranged parallel to one another, wherein the drive belt has at least one second conducting element for transmitting data. The second conducting element has a substrate with conductor tracks printed thereon.

### CROSS-REFERENCE TO RELATED APPLICATIONS

This application is a National Stage Application under 35 U.S. C. § 371 of International Patent Application No. PCT/DE2023/200139 filed on Jul. 10, 2023, and claims priority from German Patent Application No. 10 2022 208 243.5 filed on Aug. 8, 2022, the disclosures of which are herein incorporated by reference in their entireties.

### BRIEF SUMMARY

The invention relates to a drive belt according to the preamble of claim 1. The invention moreover relates to a linear drive and to a storage and retrieval unit.

In many applications and fields, drive belts are used for driving and for transmitting forces in working machines, transport means, vehicles, etc., specifically both as revolving drive belts in a traction belt drive and as drive belts of finite length in a linear drive or in an elevator installation.

In particular in the case of linear drives, parts of the respective device are moved with the aid of the drive belts used therein, for example in the case of a carriage that is moved in a plurality of directions of a working machine, for instance a milling machine or a storage and retrieval unit, or else in the case of a driven print head of a 3D printer.

Usually, in the case of such linear drives for transmitting energy and/or for transmitting measurement signals and control signals, what is referred to as a “cable carrier” is additionally carried along, essentially between the moving part of the working machine and the drive or the central control device, which also processes the signals from the stationary operating devices that are likewise connected thereto. The term “cable carrier” refers to an energy chain by means of which longer cables, energy supplies and control lines are guided on supporting, movable, chain-like holders of a moving machine or a movable device. In this case, the cable carrier thus travels along with the moving part of the working machine, may also have to be deflected and requires corresponding installation space.

Alternatively, a wide variety of embodiments of sliding contacts, for example in the form of current-carrying rails, can be used. Sliding contacts are particularly sensitive to contamination, for which reason the maintenance of the sliding contacts for reliable current and/or signal transmission is very complex and expensive.

Such an energy chain is of course subject to the relevant regulations with regard to servicing and maintenance and has to be checked regularly, as does the actual drive via drive belts. Compliance with such regulations therefore requires regular monitoring and maintenance of the energy chain as well and thus involves considerable additional outlay.

DE 10 2012 011 230 A1 discloses an apparatus for force and/or movement transmission, in particular for conveying devices, having a drive belt with electrically conductive reinforcing members, wherein the reinforcing members are designed to transfer electrical energy from an input coupling element via the drive belt to an output coupling element, in order to supply one or more drives with electrical energy. Disadvantageously, the metallic reinforcing members have an electrical conductivity that is too low and attenuation properties that are too high to be able to ensure that data signals are optimally transmitted. Data signals therefore have to continue to be transmitted via cables provided for this purpose, this being associated with the above-described disadvantages of the cable carrier.

EP 3 462 055 B1 discloses an elevator installation having a carrier belt in the form of a drive belt having tensile members for signal or data transmission. The signals or data are fed in or read out between signal-conducting elements and further lines or signal-processing devices via contact-connections at the respective terminal connection points or fastening points of the signal-conducting elements via a cable clamp. Disadvantageously, the tensile members, as described above, have an electrical conductivity that is insufficient for transmitting data signals and an attenuation that is too high, for which reason signals or data cannot be reliably transmitted. A further disadvantage is a complex process for contact-connecting the tensile members since, prior to the electrical contact-connecting, each individual tensile member has to be manually freed from the elastomer material surrounding it. In order to avoid the risk of a short circuit, the tensile members must in turn be insulated from one another in order to subsequently be connected to the cable clamp. Such complicated contact-connecting of the tensile members results in correspondingly high production costs.

The invention is based on the object of providing a drive belt, for example for a linear drive, that is designed both for transmitting current and for transmitting data signals.

Additionally or alternatively, the quality of the transmission of data signals by the drive belt is intended to be further improved.

Additionally or alternatively, the tensile members are intended to be contact-connected quickly and/or inexpensively and/or automatably.

Another object is that of providing a linear drive having a drive belt and of providing a storage and retrieval unit having a linear drive, wherein no additional cable carrier is intended to be required for transmitting current and data signals.

This object is achieved by a drive belt having the features of independent claim 1.

This object is also achieved by a linear drive having a drive belt according to the invention.

Claim 14 moreover relates to a storage and retrieval unit having a linear drive according to the invention.

Further advantageous embodiments are disclosed in the dependent claims. Further advantages and features can be found in the general description and in the exemplary embodiments.

The present application relates to a drive belt, having a first conducting element, which is embedded in a polymer material, for transmitting electrical energy, wherein the first conducting element is formed by at least one tensile member that extends in the longitudinal direction of the drive belt, preferably a multiplicity of tensile members that extend in the longitudinal direction of the drive belt and are arranged parallel to one another.

In other words, the tensile member, which can be formed from an electrically conductive material, preferably from metal, can, in addition to the actual function of force transmission, additionally carry current. This enables current to be conducted from an energy source to a load, for example an electric motor of an actuating drive, via the drive belt, without requiring additional cables for carrying current. Preferably, the polymer material of the drive belt is a polyurethane.

In addition to the tensile member as a first conducting element for carrying current, the drive belt has at least one second conducting element for transmitting data. The second conducting element has a substrate with conductor tracks printed thereon. The conductor tracks can be applied to the substrate by means of generally known printing processes using an electrically conductive ink. The electrical conductivity and the attenuation properties of the conductor tracks can be influenced by selecting a suitable electrically conductive material for the ink. For improved signal transmission, the second conducting element has a lower attenuation compared to the first conducting element. A suitable electrically conductive material for the ink is, in particular, copper, silver or gold. The electrically conductive material can be in pure form, in particle form or in the form of a dispersion. The second conducting element is designed to transmit data, for example sensor data for controlling and monitoring the position of the electric motor of the actuating drive. The second conducting element can be applied to the surface of the drive belt or embedded in the polymer material of the drive belt as an integral constituent of the drive belt.

It has proven to be particularly advantageous that a separate cable carrier or an energy chain, which have to be moved and guided as separate elements along with moving devices or machine parts, can be dispensed with. Accordingly, the maintenance for such systems can also be carried out together with the maintenance for the drive belt. A further advantage is that the electrical conductivity and/or the attenuation properties of the printed conductor tracks can be adapted to the required quality of the data to be transmitted by selecting the constituents of the electrically conductive ink in a targeted manner. In other words, the quality of the data transmission can be influenced in a targeted manner using simple means without influencing the mechanical properties of the drive belt.

According to another aspect of the present invention, the drive belt is designed as a toothed belt, flat belt, V-belt or V-ribbed belt. The properties and advantages explained at the outset can thus apply to various types of drive belts.

According to another aspect of the present application, the drive belt is a non-closed drive belt having a predetermined length and two ends. Particularly advantageously, cutting the drive belt to size enables it to be provided at any desired length without incurring costs for individual tools for producing a drive belt of a specific length.

According to another aspect of the present invention, the substrate comprises the polymer material of the drive belt. Preferably, the substrate consists of the polymer material of the drive belt. Advantageously, this enables improved bonding of the substrate to the polymer material of the drive belt, wherein the substrate can be integrally bonded to the polymer material of the drive belt under the action of heat. This enables the substrate to be an integral constituent of the drive belt, as a result of which the drive belt can retain its original mechanical properties.

According to another aspect of the present invention, the substrate and in particular the conductor tracks are embedded in the polymer material of the drive belt. It has proven to be particularly advantageous that the substrate and the conductor tracks applied thereto can be protected from external influences such as, for example, mechanical abrasion or other environmental influences, by the polymer material of the drive belt. The data transmission can thus be ensured particularly reliably over the service life of the drive belt.

According to another aspect of the present invention, the drive belt has at least one connection adapter, which is arranged in particular at one end of the drive belt, preferably at an end side of the drive belt, wherein the first conducting element and the second conducting element are combined in the connection adapter for feeding in and/or tapping the electrical energy and the data. In other words, the connection adapter can be designed as a standardized connector, for example as a CAN bus connector. The drive belt can preferably have the connection adapter both at the first end and at the second end. The connection adapter can advantageously have the number of pins that corresponds to the sum of the number of tensile members of the first conducting element and the conductor tracks of the second conducting element. It has proven to be particularly advantageous that a pin of the connection adapter of the first end of the drive belt can be assigned to a corresponding pin of the connection adapter of the second end and is electrically conductively connected thereto. This enables the connection adapter to be particularly advantageously connected to devices such as, for example, a voltage supply and/or a control device of a machine. Furthermore, the drive belt can be integrated in existing systems easily and without further structural outlay via a standardized interface as a current and data transmission apparatus.

According to another aspect of the present invention, the drive belt has at least one contact-connection element to which the first conducting element is electrically connected at the end, wherein the contact-connection element connects the first conducting element to the connection adapter. The drive belt can preferably have the contact-connection element both at the first end and at the second end. It has proven to be particularly advantageous that an interface, which enables the first conducting element or the tensile member to be electrically conductively connected to further devices for supplying current and/or for consuming current, can be provided via the contact-connection element.

According to another aspect of the present invention, the contact-connection element is connected to a cable that leads into the connection adapter. The cable can be designed as a ribbon cable. In other words, the first conducting element can be electrically conductively connected to the contact-connection element over a spatial distance by the cable. It has proven to be particularly advantageous that the connection adapter can be connected to the flexible cable instead of the rigid tensile member of the first conducting element, as a result of which the first conducting element remains reliably connected to the connection adapter even in the case of dynamic mechanical loading.

According to another aspect of the present invention, the contact-connection element has at least one pair, preferably a multiplicity of pairs arranged in the transverse direction, of fork-shaped prongs that extend in the vertical direction for receiving at least one tensile member that extends in the longitudinal direction of the drive belt, preferably a multiplicity of tensile members that extend in the longitudinal direction of the drive belt and are arranged parallel to one another. The contact-connection element is inserted into the polymer material in the vertical direction. The contact-connection element can preferably have the same number of pairs of fork-shaped prongs as tensile members. In other words, the contact-connection element can be electrically conductively connected to the tensile member of the drive belt without the tensile member having to be freed from the polymer material of the drive belt. The spacing between two fork-shaped prongs of a pair in the transverse direction can in this case correspond at most to the diameter of the tensile member. The spacing between two fork-shaped prongs of a pair in the transverse direction preferably corresponds to 80 percent of the diameter of the tensile member. Particularly advantageously, when a spacing between two fork-shaped prongs is smaller than the diameter of the tensile member, particularly good electrically conductive contact can be established between the tensile member and the contact-connection element. Any deformation of the tensile member in relation to the spacing of the pair of fork-shaped prongs, between which the tensile member can be received, advantageously causes an increase in the contact surface area between the tensile member and the pair of fork-shaped prongs of the contact-connection element. No polymer material is present in the contact region between the tensile member and the pair of fork-shaped prongs. The pairs of fork-shaped prongs can be arranged with respect to one another in the spacing between the tensile members. This makes it possible to ensure that one tensile member is assigned to each pair of fork-shaped prongs and/or that the tensile member is not damaged when the contact-connection element is inserted into the polymer material of the drive belt and/or the position of the tensile member in the drive belt is changed. However, a pair of fork-shaped prongs can also receive or contact-connect a plurality of tensile members. In order to enable the contact-connection element to be inserted into the polymer material of the drive belt with the lowest possible force, the polymer material and/or the contact-connection element can be heated. The polymer material may soften due to the influence of heat, as a result of which the resistance of the polymer material to the insertion of the fork-shaped prongs of the contact-connection element may decrease. In addition, the fork-shaped prongs of the contact-connection element can have knife-like cutting edges, which also make it easier to insert the contact-connection element into the polymer material.

According to another aspect of the present invention, the contact-connection element has at least one cylindrical sleeve for receiving a tensile member. The cylindrical sleeve is inserted into the polymer material in the longitudinal direction and encloses the tensile member over a partial length in the longitudinal direction, wherein the cylindrical sleeve is pressed onto the tensile member. Particularly preferably, the drive belt has the same number of cylindrical sleeves as tensile members, so that each tensile member has a cylindrical sleeve as a contact-connection element. In other words, the cylindrical sleeve can be electrically conductively connected to the tensile member of the drive belt without the tensile member having to be freed from the polymer material of the drive belt. In order to enable the cylindrical sleeve to be inserted into the polymer material of the drive belt with the lowest possible force, the polymer material and/or the cylindrical sleeve can be heated. The polymer material may soften due to the influence of heat, as a result of which the resistance of the polymer material to the insertion of the cylindrical sleeve may decrease. Applying a force to the drive belt in the vertical direction causes the cylindrical sleeve to be pressed together with the tensile member. This enables the electrically conductive connection between the cylindrical sleeve and the tensile member to be improved and permanently ensured under dynamic loading of the drive belt. No polymer material is present in the contact region between the tensile member and the cylindrical sleeve.

According to another aspect of the present invention, the contact-connection element has at least one mandrel, which is inserted into the tensile member in the longitudinal direction. In order to enable the mandrel to be inserted into the tensile member of the drive belt with the lowest possible force, the polymer material of the drive belt and/or the mandrel can be heated. The polymer material may soften due to the influence of heat, as a result of which the resistance of the polymer material to widening of the diameter of the tensile member when the mandrel is inserted into the tensile member may decrease. The mandrel is preferably designed with a tapering outer contour, for example conically, so that the force for inserting the mandrel into the tensile member can additionally be reduced. Particularly preferably, the drive belt has the same number of mandrels as tensile members, so that each tensile member has a mandrel as a contact-connection element. It has proven to be particularly advantageous that the contact surface area between the tensile member and the mandrel inserted therein for forming an electrically conductive connection is particularly large. Inserting the mandrel into the tensile member enables any contact between the mandrel and the electrically insulating polymer material of the drive belt to be avoided. In other words, the contact resistance between the mandrel and tensile member can particularly advantageously be kept as low as possible, as a result of which electrical losses when carrying current can likewise be low.

According to another aspect of the present invention, the contact-connection element has at least one clip, which in particular has a U-shaped design and is inserted into the polymer material in the vertical direction and contactingly surrounds the tensile member. In other words, the contact-connection element can be designed as a U-shaped wire. In this case, the wire can be designed with a U-shaped radius that corresponds to the outer diameter of the tensile member. The wire may be inserted in the shape of a U, with a first wire end and a second wire end, into the polymer material of the drive belt in the vertical direction, so that a tensile member is received between the first wire end and the second wire end. The wire can pass through the drive belt in the vertical direction, so that the first wire end and the second wire end project out from the opposite side of the drive belt. The wire can be heated, for example by applying a voltage, as a result of which the polymer material of the drive belt can be softened or melted, as a result of which the U-shaped part of the wire can be moved with a small amount of force through the polymer material as far as the tensile strand and electrically conductive contact can be formed between the wire and the tensile strand. The point at which the wire penetrates into the polymer material of the drive belt can be closed again by heating the wire and the polymer material surrounding the wire, as described above. The tensile member can be electrically conductively connected, via the first wire end and the second wire end, to further devices for supplying current and/or for consuming current. Particularly preferably, the drive belt has the same number of clips or wires as tensile members, so that a clip or a wire is assigned as a contact-connection element to each tensile member.

The application moreover relates to a linear drive having a drive belt according to the invention. The linear drive may comprise, in addition to the drive belt, a drive, for example in the form of an electric motor, at least one belt pulley around which the drive belt is looped and a platform which can move linearly along the drive belt. The abovementioned properties and advantages can thus apply to a wide variety of embodiments of linear drives.

The application furthermore relates to a storage and retrieval unit having a linear drive according to the invention. In particular in the case of storage and retrieval units, there is a requirement for the mass of the linear drive to be kept as low as possible in order to be able to transport loads that are as heavy as possible. In other words, a saving in weight of the linear drive as a result of the solution according to the invention on account of separate cables no longer being required for supplying an electric drive or for transmitting data signals from a sensor can lead directly to an increase in the payload of the storage and retrieval unit.

It is expressly pointed out that the above-explained configurations of the invention, each taken alone or in any technically meaningful combination with one another as well, are each combinable with the subject matter of claim 1 and/or the remaining independent claims 13 and 14.

Exemplary embodiments of the invention will be illustrated schematically and explained in more detail below with reference to the figures.

### BRIEF DESCRIPTION OF THE DRAWINGS

FIGS. 1a and 1b show a schematic cross-sectional illustration of a drive belt according to the invention according to a first exemplary embodiment for contact-connecting a first conducting element.

FIGS. 2a, 2b and 2c show a schematic illustration of a drive belt according to the invention according to a second exemplary embodiment for contact-connecting a first conducting element.

FIGS. 3a and 3b show a schematic illustration of a side view of a drive belt according to the invention according to a third exemplary embodiment for contact-connecting a first conducting element.

FIGS. 4a and 4b show a schematic cross-sectional illustration of a drive belt according to the invention according to a fourth exemplary embodiment for contact-connecting a first conducting element.

FIG. 5 shows a schematic illustration of a drive belt according to the invention having a first conducting element and a connection adapter.

FIG. 6 shows a schematic illustration of the drive belt according to the invention from FIG. 5 having a second conducting element and a connection adapter.

The description of the aforementioned figures is given in Cartesian coordinates with a longitudinal direction X, a transverse direction Y, which is perpendicular to the longitudinal direction X, and a vertical direction Z, which is perpendicular both to the longitudinal direction X and to the transverse direction Y. The longitudinal direction X may also be referred to as the depth X, the transverse direction Y may also be referred to as the width Y, and the vertical direction Z may also be referred to as the height Z. The longitudinal direction X and the transverse direction Y together form the horizontal X, Y, which can also be referred to as the horizontal plane X, Y. The longitudinal direction X, the transverse direction Y and the vertical direction Z can also be referred to together as spatial directions X, Y, Z or as Cartesian spatial directions X, Y, Z.

### DETAILED DESCRIPTION

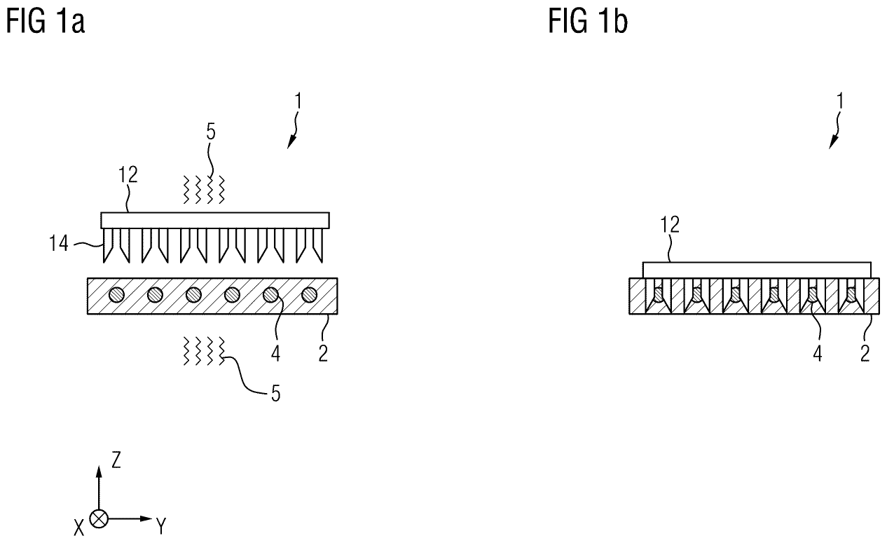

FIG. 1a shows a first embodiment of the drive belt 1 according to the invention, having a first conducting element 4, which is embedded in a polymer material 2, for transmitting electrical energy, wherein the first conducting element 4 is formed by at least one tensile member 4 that extends in the longitudinal direction X of the drive belt 1, preferably a multiplicity of tensile members 4 that extend in the longitudinal direction X of the drive belt 1 and are arranged parallel to one another. In order to transmit data, the drive belt 1 has at least one second conducting element 6. The second conducting element 6 has a substrate 7 with conductor tracks 8 printed thereon. The drive belt 1 has a contact-connection element 12 with six pairs of fork-shaped prongs 14, wherein the contact-connection element 12 is designed to be electrically conductively connected to the tensile member 4. The fork-shaped prongs 14 extend in the vertical direction Z and are arranged in the form of six pairs in a transverse direction Y. The exemplary embodiment illustrated has six pairs or twelve fork-shaped prongs 14. The schematically illustrated drive belt 1 has six tensile members 4, which are embedded in a polymer material 2, preferably polyurethane. The tensile members 4 form a first conducting element 4 for current transmission and comprise a metallic material. The tensile members 4 extend in the longitudinal direction X of the drive belt 1 and are arranged so as to be spaced apart from one another in the transverse direction Y. The spacing between two fork-shaped prongs 14 of a pair in the transverse direction Y corresponds to 80 percent of the diameter of the tensile member. The pairs of fork-shaped prongs 14 are arranged with respect to one another in the spacing between the tensile members 4. Thus, one tensile member 4 is assigned to each pair of fork-shaped prongs 14. Aligning the fork-shaped prongs 14 with respect to the tensile members 4 prevents the tensile members 4 from being damaged when the contact-connection element 12 is inserted into the polymer material 2 of the drive belt 1. The polymer material 2 of the drive belt 1 and the contact-connection element 12 are heated by a heat source 5. The heating causes the polymer material 2 to soften and to present a lower resistance to insertion of the contact-connection element 12 into the polymer material 2, as a result of which the contact-connection element 12 can be inserted into the polymer material 2 in the vertical direction Z with a small amount of force.

FIG. 1b shows the drive belt 1 and the contact-connection element 12 from FIG. 1a, wherein the contact-connection element 12 has been inserted into the polymer material 2 of the drive belt 1 and is electrically conductively connected to the tensile member 4. The pairs of fork-shaped prongs 14 each receive one tensile member 4 between them. The contact-connection element 12 can be electrically conductively connected to the tensile members 4 of the drive belt 1 without the tensile members 4 having to be freed from the polymer material 2 of the drive belt 1. By virtue of the fact that the spacing between the pairs of fork-shaped prongs 14 is smaller than the diameter of the tensile members 4, the tensile members 4 are deformed between the pairs of fork-shaped prongs 14, as a result of which the contact surface area between the tensile member 4 and the pair of fork-shaped prongs 14 of the contact-connection element 12 increases.

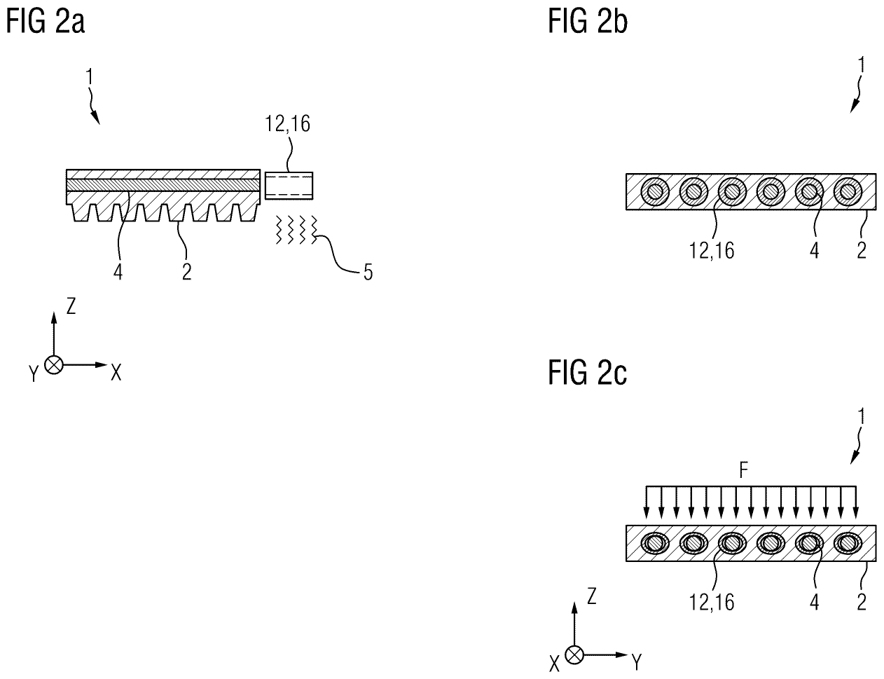

FIG. 2a shows a side view of another embodiment of the drive belt 1 according to the invention in the form of a toothed belt. The contact-connection element 12 is designed as a cylindrical sleeve 16 for receiving a tensile member 4. The cylindrical sleeve 16 is inserted into the polymer material 2 of the drive belt 1 in the longitudinal direction X and encloses the tensile member 4 over a partial length in the longitudinal direction X. In order to make it easier to insert the cylindrical sleeve 16, the polymer material 2 of the drive belt 1 and the cylindrical sleeve 16 are heated by the heat source 5.

FIG. 2b shows a cross-sectional illustration of the exemplary embodiment from FIG. 2a. It can be seen here that one cylindrical sleeve 16 is assigned in each case as a contact-connection element 12 to each tensile member 4.

FIG. 2c shows that, as a result of a force F being applied to the drive belt 1 in the vertical direction Z, the cylindrical sleeves 16 are plastically deformed and are electrically conductively connected to the tensile members 4. No polymer material 2 is present in the contact region between the tensile member 4 and the cylindrical sleeve 16.

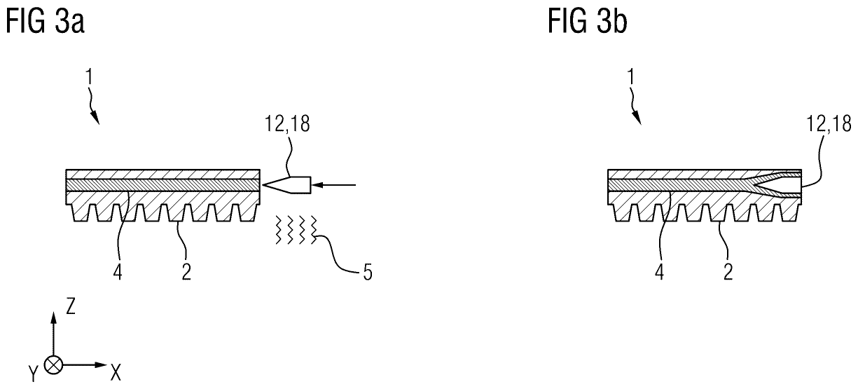

FIG. 3a shows a side view of another embodiment of the drive belt 1 according to the invention in the form of a toothed belt, wherein the contact-connection element 12 is designed as a mandrel 18. In order to keep the force required for inserting the mandrel 18 into the tensile member 4 of the drive belt 1 in the longitudinal direction X as low as possible, the mandrel 18 is heated by a heat source 5. The polymer material 2 may soften due to the influence of heat, as a result of which the resistance of the polymer material 2 to widening of the diameter of the tensile member 4 when the mandrel 18 is inserted into the tensile member 4 decreases. The diameter of the mandrel 18 widens conically, with the result that the force required for inserting the mandrel 18 into the tensile member 4 is additionally reduced. The drive belt 1 has the same number of mandrels 18 as tensile members 4, so that each tensile member 4 has a mandrel 18 as a contact-connection element 12.

FIG. 3b shows the drive belt 1 from FIG. 3a, wherein the mandrel 18 has been inserted into the tensile member 4 in the longitudinal direction X. The tensile member 4 has widened in diameter in the region around the mandrel 18. The mandrel 18 is substantially surrounded by the tensile member. As a result of the contact between the mandrel 18 and the tensile member 4, an electrically conductive connection is formed between the mandrel 18 and the tensile member 4.

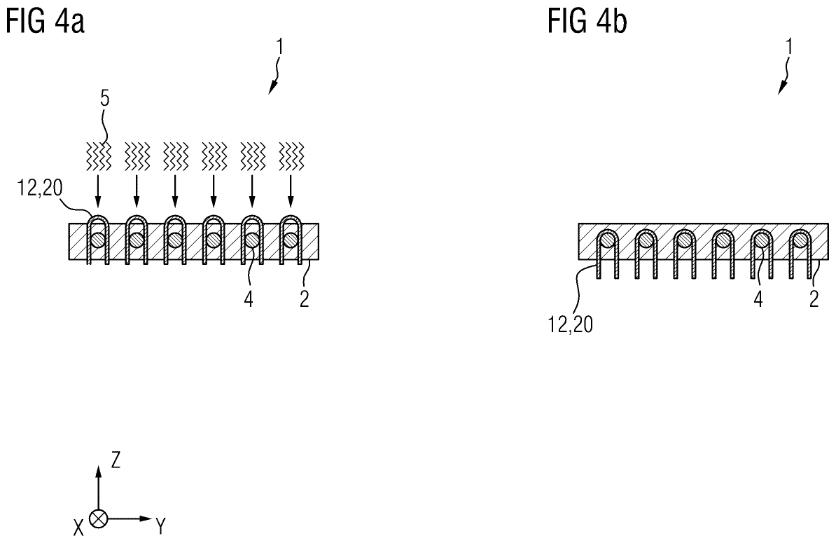

FIG. 4a shows a cross section through another embodiment of the drive belt 1 according to the invention, wherein the contact-connection element 12 is designed as a U-shaped wire 20. The wire 20 is inserted in the shape of a U, with a first wire end and a second wire end, into the polymer material 2 of the drive belt 1 in the vertical direction Z, so that a tensile member 4 is received between the first wire end and the second wire end. The wire 20 passes through the drive belt 1 in the vertical direction Z, so that the first wire end and the second wire end project out from the opposite side of the drive belt 1. The wire 20 is heated, for example by applying a voltage to the first wire end and to the second wire end, as a result of which the polymer material 2 of the drive belt 1 softens or melts, as a result of which the U-shaped part of the wire 20 is moved with a small amount of force through the polymer material 2 as far as the tensile strand 4. The drive belt 1 has the same number of wires 20 as tensile members 4, so that a wire 20 is assigned as a contact-connection element 12 to each tensile member 4.

FIG. 4b shows the drive belt 1 from FIG. 4a, wherein the wires 4 are inserted into the polymer material 2 of the drive belt 1 in the vertical direction Z to such an extent that the tensile members 4 are surrounded in a U-shaped manner by the wires 20 and electrically conductive contact is formed between the wire 20 and the tensile strand 4. The U-shaped radius of the wire 20 corresponds to the outer diameter of the tensile member 4.

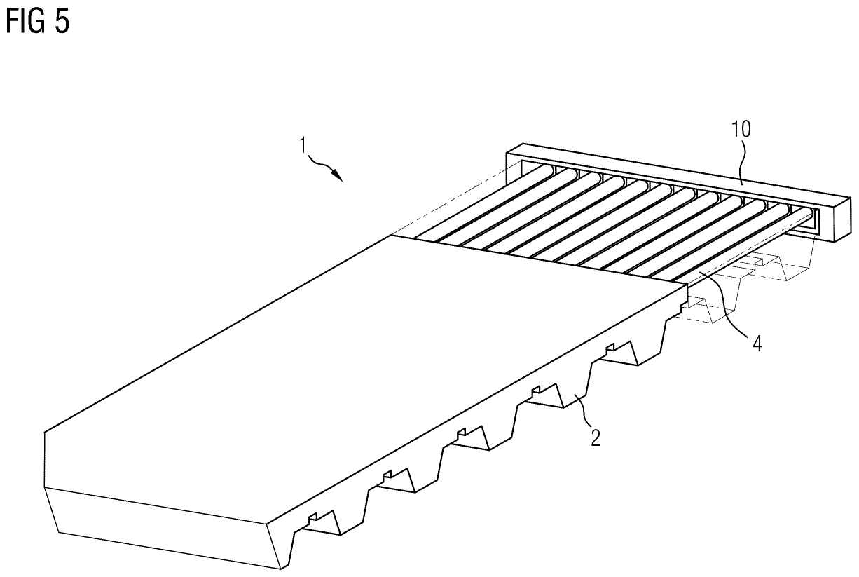

FIG. 5 shows another embodiment of the drive belt 1 according to the invention in the form of a toothed belt having a main body made from polymer material 2. Tensile members 4, which are arranged parallel to one another and form a first conducting element 4 for carrying current, extend in the longitudinal direction X of the drive belt 1. The tensile members 4 converge in a connection adapter 10, which is formed for example by a CAN bus connector. The connection adapter 10 forms a standardized interface for feeding in and/or tapping electrical energy, which is conducted via the tensile members 4 through the drive belt 1 from a voltage supply to a load, for example an electric motor. Each tensile member 4 is individually contact-connected via a pin of the connection adapter 10. In this case, the contact-connection element can be contact-connected to the connection adapter according to one of the variants shown in FIGS. 1a to 4b.

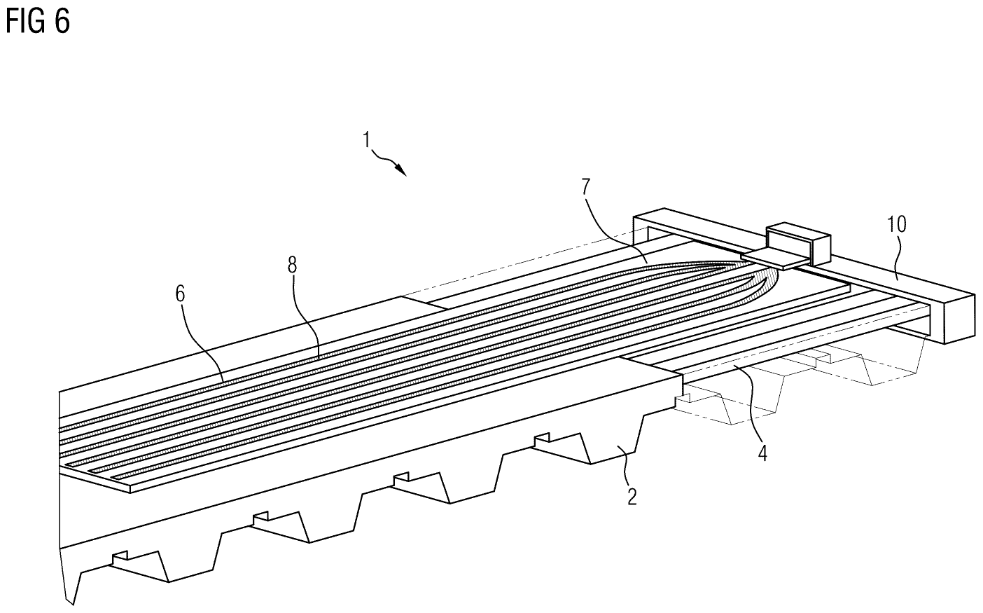

FIG. 6 shows the drive belt 1 according to the invention according to FIG. 5, wherein, in addition to the tensile members 4 as the first conducting element 4, a second conducting element 6 is formed by a substrate 7 having conductor tracks 8 printed on the substrate 7. The conductor tracks 8 converge together with the tensile members 4 in the connection adapter 10. In addition to the individual tensile members 4, a pin of the connection adapter 10 is assigned to each conductor track 8, so that each tensile member 4 and each conductor track 8 are individually contact-connected. Electrical energy and/or data can be fed into and/or read out of the drive belt 1 via the connection adapter 10. The conductor tracks 8 of the second conducting element 6 have at least constituents made from copper, silver or gold, as a result of which the conductor tracks 8 have a lower attenuation compared to the tensile members 4 of the first conducting element 4, thereby improving the quality of the signal transmission via the conductor tracks 8.

### LIST OF REFERENCE SIGNS (PART OF THE DESCRIPTION)

1 Drive belt
2 Polymer Material
4 First conducting element, tensile member
5 Heat source
6 Second conducting element
7 Substrate
8 Conductor track
10 Connection adapter
12 Contact-connection element
14 Fork-shaped prongs
16 Cylindrical sleeve
18 Mandrel
20 Wire
F Force
X Longitudinal direction; depth
Y Transverse direction; width
Z Vertical direction; height
X, Y Horizontal; horizontal plane

1. A drive belt comprising:
a first conducting element which is embedded in a polymer material for transmitting electrical energy,
wherein the first conducting element is formed by a plurality of tensile members that extend in a longitudinal direction (X) of the drive belt and are arranged parallel to one another,
wherein the drive belt has at least one second conducting element for transmitting data,
wherein the second conducting element has a substrate with conductor tracks printed thereon.

2. The drive belt as claimed in claim 1,
wherein the drive belt is designed as one of a group comprising a toothed belt, flat belt, V-belt or V-ribbed belt.

3. The drive belt of claim 1, wherein the drive belt is a non-closed drive belt having a predetermined length and two ends.

4. The drive belt of claim 1, wherein
the substrate consists of, the polymer material of the drive belt.

5. The drive belt of claim 1, wherein
the substrate and the conductor tracks are embedded in the polymer material of the drive belt.

6. The drive belt of claim 1, wherein
the drive belt has at least one connection adapter, which is arranged in particular at an end side of the drive belt, wherein the first conducting element and the second conducting element are combined in the connection adapter for feeding in and/or tapping the electrical energy and the data.

7. The drive belt as claimed in claim 6,
wherein the drive belt has at least one contact-connection element to which the first conducting element is electrically connected at the end, wherein the contact-connection element connects the first conducting element to the connection adapter.

8. The drive belt as claimed in claim 7,
wherein the contact-connection element is connected to a cable that leads into the connection adapter.

9. The drive belt as claimed in claim 8,
wherein the contact-connection element
has at least one pair of fork-shaped prongs extending in a vertical direction (Z) for receiving the tensile members that extends in the longitudinal direction (X) of the drive belt,
wherein the contact-connection element is inserted into the polymer material in the vertical direction (Z).

10. The drive belt of claim 8,
wherein the contact-connection element has at least one cylindrical sleeve for receiving a tensile member of the plurality of tensile members,
wherein the cylindrical sleeve is inserted into the polymer material in the longitudinal direction (X) and encloses the tensile member over a partial length in the longitudinal direction (X),
wherein the cylindrical sleeve is pressed onto the tensile member.

11. The drive belt of claim 8,
wherein the contact-connection element has at least one mandrel, which is inserted into the tensile member in the longitudinal direction (X).

12. The drive belt of claim 8,
wherein the contact-connection element has at least one clip, which in particular has a U-shaped design and is inserted into the polymer material in the vertical direction (Z) and contactingly surrounds the tensile member.

13. The drive belt of claim 1, wherein the drive belt is in a linear drive.

14. The drive belt of claim 1, wherein the drive belt is within a storage and retrieval unit.

15. A drive belt comprising:
a first conducting element embedded in a polymer material for transmitting electrical energy;
the first conducting element is formed by a plurality of tensile members that extend in a longitudinal direction (X) of the drive belt and are arranged parallel to one another;
the drive belt has at least one second conducting element for transmitting data;
the second conducting element has a substrate with conductor tracks printed thereon;
the drive belt is a non-closed drive belt having a predetermined length and two ends;
the substrate consists of the polymer material of the drive belt;
the substrate and the conductor tracks are embedded in the polymer material of the drive belt;
the drive belt has at least one connection adapter arranged at an end side of the drive belt, wherein the first conducting element and the second conducting element are combined in the connection adapter for feeding in and/or tapping the electrical energy and the data;
the drive belt has at least one contact-connection element to which the first conducting element is electrically connected at the end, wherein the contact-connection element connects the first conducting element to the connection adapter;
the contact-connection element is connected to a cable that leads into the connection adapter;
the contact-connection element has at least one pair of fork-shaped prongs extending in a vertical direction (Z) for receiving the tensile members that extends in the longitudinal direction (X) of the drive belt; and
wherein the contact-connection element is inserted into the polymer material in the vertical direction (Z).
